(19) United States
(12) Patent Application Publication
(10) Pub. No.: US 2025/0022315 A1
(43) Pub. Date: Jan. 16, 2025

(54) DETECTION METHOD AND APPARATUS, SRORAGE MEDIUM AND ELECTRONIC DEVICE

(71) Applicant: MaShang Consumer Finance Co., Ltd., Chongqing (CN)

(72) Inventors: Xingfu ZHAO, Chongqing (CN); Ning JIANG, Chongqing (CN); Haiying WU, Chongqing (CN)

(21) Appl. No.: 18/896,742

(22) Filed: Sep. 25, 2024

Related U.S. Application Data
(63) Continuation of application No. PCT/CN2023/108638, filed on Jul. 21, 2023.

(30) Foreign Application Priority Data
Aug. 17, 2022 (CN) 202210987670.1

(51) Int. Cl. G06V 40/20; G06V 10/75; G06V 40/16

(52) U.S. Cl. CPC G06V 40/20; G06V 10/751; G06V 40/171

(57) ABSTRACT

The present application relates to the field of image processing technology, specifically to a lip movement detection method and apparatus, a computer-readable storage medium and an electronic device, solving the problem of weak generalization ability and poor robustness of traditional lip movement detection method. The lip movement detection method provided in an embodiment of the present application determines a lip movement detection result of a user based on a reference interlabial distance of the user in a first image frame, where the reference interlabial distance is determined based on a correspondence between an interlabial distance and a reference value for interlabial distance, thus the reference interlabial distance is a relative value. That is, the reference interlabial distance is not easily affected by factors such as shooting angle and shooting distance, thereby improving the robustness of the lip movement detection method.

### CROSS-REFERENCE TO RELATED APPLICATIONS

This application is a continuation of International Application No. PCT/CN2023/108638, filed on Jul. 21, 2023, which claims priority to Chinese Patent Application No. 202210987670.1 filed with the China National Intellectual Property Administration on Aug. 17, 2022, which is hereby incorporated by reference in its entirety.

### TECHNICAL FIELD

The present application relates to the field of image processing technology, specifically to a detection method and apparatus, a computer-readable storage medium and an electronic device.

### BACKGROUND

A lip movement detection method is a detection method that detects a facial image or a facial video to obtain movement status of a lip. At present, it is common to first use a large number of samples to train and generate a lip movement detection model, and then use the trained lip movement detection model for lip movement detection.

### SUMMARY

In view of this, embodiments of the present application provide a lip movement detection method and apparatus, a computer-readable storage medium and an electronic device.

In a first aspect, an embodiment of the present application provides a lip movement detection method, including: determining, based on a first image frame including a facial region of a user, an interlabial distance and a reference value for interlabial distance of the user in the first image frame; determining, based on a correspondence between the interlabial distance and the reference value for interlabial distance, a reference interlabial distance of the user in the first image frame; and determining, based on the reference interlabial distance of the user in the first image frame, a lip movement detection result of the user.

In a second aspect, an embodiment of the present application provides a lip movement detection method for a virtual digital human, including: obtaining a to-be-processed video including a facial region of the virtual digital human; and processing, based on the lip movement detection method according the first aspect, an image frame included in the to-be-processed video, to obtain a lip movement detection result of the virtual digital human.

In a third aspect, an embodiment of the present application provides a lip movement detection apparatus, including: a first determination module, configured to determine, based on a first image frame including a facial region of a user, an interlabial distance and a reference value for interlabial distance of the user in the first image frame; a second determination module, configured to determine, based on a correspondence between the interlabial distance and the reference value for interlabial distance, a reference interlabial distance of the user in the first image frame; and a third determination module, configured to determine, based on the reference interlabial distance of the user in the first image frame, a lip movement detection result of the user.

In a fourth aspect, an embodiment of the present application provides a lip movement detection apparatus for a virtual digital human, including: an acquisition module, configured to obtain a to-be-processed video including a facial region of the virtual digital human; and a detection module, configured to process an image frame included in the to-be-processed video based on the lip movement detection method according to the first aspect, to obtain a lip movement detection result of the virtual digital human.

In a fifth aspect, an embodiment of the present application provides a computer-readable storage medium storing with instructions that, when executed by a processor of an electronic device, enable the electronic device to execute the methods mentioned above.

In a sixth aspect, an embodiment of the present application provides an electronic device, including: a processor; a memory configured to store computer executable instructions; where the processor is configured to execute the computer executable instructions to implement the methods mentioned above.

In a seventh aspect, an embodiment of the present application provides a computer program that implements the method mentioned above when executed by a processor.

In an eighth aspect, an embodiment of the present application provides a computer program product including a computer program that implements the method mentioned above when executed by a processor.

### BRIEF DESCRIPTION OF THE DRAWINGS

FIG. 1 shows a schematic diagram of an application scenario of a lip movement detection method provided in an embodiment of the present application.

FIG. 2 shows a schematic diagram of an application scenario of a lip movement detection method provided in another embodiment of the present application.

FIG. 3 shows a flowchart of a lip movement detection method provided in an embodiment of the present application.

FIG. 4 shows a flowchart of a lip movement detection method provided in another embodiment of the present application.

FIG. 5 shows a flowchart of a lip movement detection method provided in yet another embodiment of the present application.

FIG. 6a shows a flowchart of a lip movement detection method provided in yet another embodiment of the present application.

FIG. 6b shows a flowchart of a lip movement detection method provided in yet another embodiment of the present application.

FIG. 7 is a schematic diagram of a first image frame including a set of facial keypoints provided in an embodiment of the present application.

FIG. 8 shows a flowchart of a lip movement detection method provided in yet another embodiment of the present application.

FIG. 9 shows a flowchart of a lip movement detection method provided in yet another embodiment of the present application.

FIG. 10 shows a structure schematic diagram of a lip movement detection apparatus provided in an embodiment of the present application.

FIG. 11 shows a structure schematic diagram of a lip movement detection apparatus provided in another embodiment of the present application.

FIG. 12 shows a structure schematic diagram of a lip movement detection apparatus provided in yet another embodiment of the present application.

FIG. 13 shows a structure schematic diagram of a lip movement detection apparatus provided in yet another embodiment of the present application.

FIG. 14 shows a structure schematic diagram of a lip movement detection apparatus provided in yet another embodiment of the present application.

FIG. 15 shows a structure schematic diagram of a lip movement detection apparatus provided in yet another embodiment of the present application.

FIG. 16 shows a structure schematic diagram of an electronic device provided in an embodiment of the present application.

### DESCRIPTION OF EMBODIMENTS

The technical solution in embodiments of the present application will be described clearly and completely below with reference to the accompanying drawings. Obviously, described embodiments are only a part of embodiments of the present application rather than all of them. Based on the embodiments in the present application, all other embodiments obtained by the person skilled in the art without creative labor fall within the scope of protection of the present application.

A lip movement detection method is a detection method that detects a facial image or a facial video to obtain movement status of a lip. The traditional lip movement detection method first uses a large number of samples to train and generate a lip movement detection model, and then uses the trained lip movement detection model for lip movement detection. However, in practical applications, the generalization ability and robustness of a lip movement detection model are limited by a type and a quantity of samples used to train the lip movement detection model, resulting in the generalization ability and robustness of the lip movement detection model being easily affected by factors such as sample shooting angle and shooting distance, so that leads to weak generalization ability of traditional lip movement detection methods and poor robustness of detection results.

In the present embodiment, a reference interlabial distance of a user in a first image frame is determined based on a correspondence between an interlabial distance and a reference value for interlabial distance, thus the reference interlabial distance of the user in the first image frame is a relative value. When a shooting angle changes, the interlabial distance and the reference value for interlabial distance will both decrease or increase simultaneously. Therefore, there is not much or even no change in the reference interlabial distance of the user in the first image frame determined based on the interlabial distance and the reference value for interlabial distance. That is, the reference interlabial distance of the user in the first image frame is not easily affected by factors such as shooting angle and shooting distance, thereby improving the robustness of the lip movement detection method. In addition, the present application is for lip movement detection of the first image frame, which is not limited to a type and a quantity of training samples, thereby having a strong generalization ability.

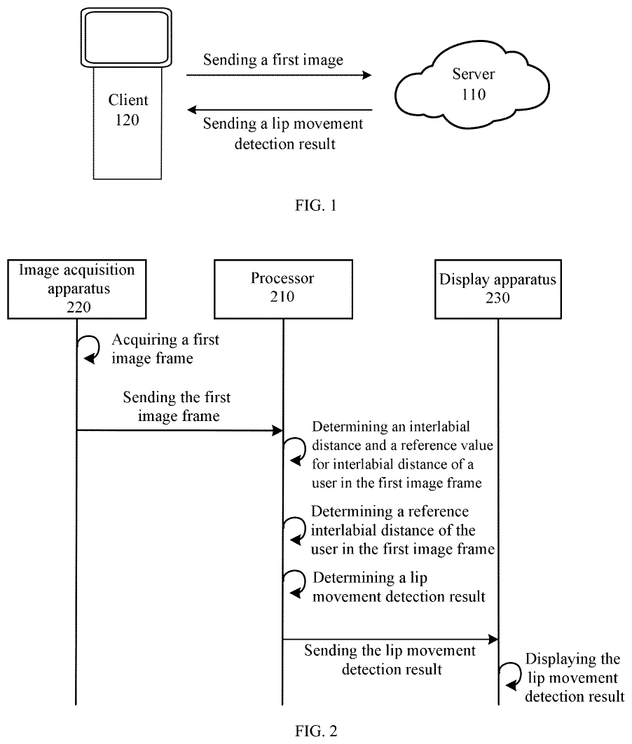

FIG. 1 shows a schematic diagram of an application scenario of a lip movement detection method provided in an embodiment of the present application. The scenario shown in FIG. 1 includes a server 110 and a client 120 communicating and connecting with the server 110. Specifically, the server 110 is configured to determine based on a first image frame including a facial region of a user, an interlabial distance and a reference value for interlabial distance of the user in the first image frame, determine, based on a correspondence between the interlabial distance and the reference value for interlabial distance, a reference interlabial distance of the user in the first image frame; and determine, based on the reference interlabial distance of the user in the first image frame, a lip movement detection result of the user. The client 120 is configured to obtain the first image frame and send the first image frame to the server 110 for the server 110 to perform the above operations.

In an embodiment of the present application, after determining the lip movement detection result, the server 110 may send the lip movement detection result to the client 120.

In an embodiment of the present application, the client 120 may display the lip movement detection result upon receiving the lip movement detection result.

The client 120 may be a human-computer interaction device, an intelligent dual recording device, etc. For example, in financial scenarios such as bank transfers and stock trading, the client 120 may record a first image frame including a face of a user and then send the facial image to the server 110. The server 110 determines a lip movement detection result and sends the lip movement detection result to the client 120 for the client 120 to judge whether the user is speaking or issuing an instruction, as well as whether the speaking user is a designated user.

FIG. 2 shows a schematic diagram of an application scenario of a lip movement detection method provided in another embodiment of the present application. The scenario shown in FIG. 2 includes a processor 210 in a human-computer interaction device and an image acquisition apparatus 220 communicating and connecting with the processor 210. Specifically, the processor 210 is configured to determine, based on a first image frame including a facial region of a user, an interlabial distance and a reference value for interlabial distance of the user in the first image frame; determine, based on a correspondence between the interlabial distance and the reference value for interlabial distance, a reference interlabial distance of the user in the first image frame; and determine, based on the reference interlabial distance of the user in the first image frame, a lip movement detection result of the user. The image acquisition apparatus 220 is configured to acquire the first image frame and send the first image frame to the processor 210 for the processor 210 to perform the above operations.

In an embodiment of the present application, the scenario shown in FIG. 2 further includes a display apparatus 230 communicating and connecting to the processor 210. After determining the lip movement detection result, the processor 210 may send the lip movement detection result to the display apparatus 230. Upon receiving the lip movement detection result, the display apparatus 230 may display the lip movement detection result. The lip movement detection result of includes: a lip movement has occurred or no lip movement has occurred.

In an embodiment of the present application, after determining the lip movement detection result, the processor 210 may also use the lip movement detection result to judge whether the user is speaking or issuing an instruction, as well as whether the speaking user is a designated user.

In an embodiment of the present application, the processor 210 may also determine, based on a preset retelling content and a lip movement detection result of the user corresponding to each of multiple image frames, whether the user has accurately stated the preset retelling content. This method can be applied to financial scenarios. Specifically, the preset retelling content may be displayed in textual form in front of the user. For example, the preset retelling content may be “Operated by myself”. The user needs to repeat the words “Operated by myself”. The image acquisition apparatus 220 acquires a video of the user repeating the words “Operated by myself”, and then sends the video to the server 210. After receiving the video, the server 210 determines a lip movement detection result for each frame of the video using the lip movement detection method of the present application, and compares the lip movement detection results corresponding to multi-frame images of the video with a preset lip movement situation of speaking the preset retelling content, to determine whether the user has accurately stated the preset retelling content.

In an embodiment of the present application, the processor 210 may also obtain speech information of the user, and then compare the lip movement detection results corresponding to multi-frame images of the received video with the speech information to determine whether time nodes of lip movements are consistent with time nodes of the speech signal in the speech information, thereby determining whether the speech information and the received video belong to the same user.

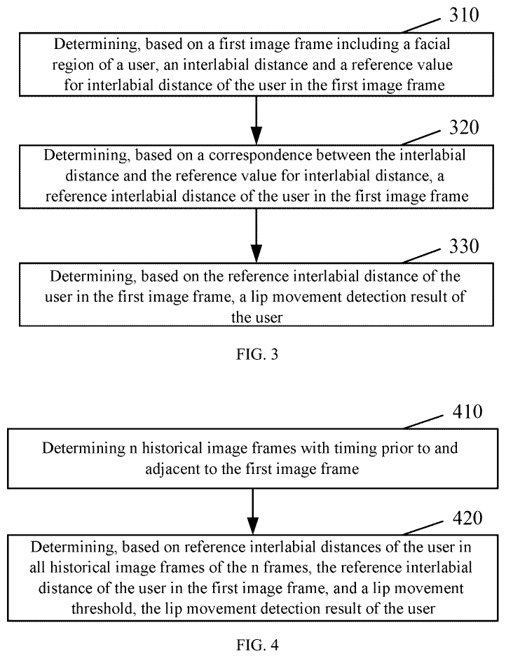

FIG. 3 shows a flowchart of a lip movement detection method provided in an embodiment of the present application. As shown in FIG. 3, the lip movement detection method includes the following steps.

Step 310, determining, based on a first image frame including a facial region of a user, an interlabial distance and a reference value for interlabial distance of the user in the first image frame.

The first image frame may be an image including an entire face, or may be an image only including lips and surrounding thereof. The interlabial distance may be a distance between an upper lip and a lower lip. The reference value for interlabial distance may be a distance between two parts of the user (such as a nose bottom and the upper lip) in the first image frame.

Exemplarily, facial keypoints of the user in the first image frame may be used to determine the interlabial distance and the reference value for interlabial distance. A prior model may also be used to determine the interlabial distance and the reference value for interlabial distance.

In an embodiment of the present application, the reference value for interlabial distance may be a distance between a nose bottom and an upper lip of the user in the first image frame. Due to a distance between the nose and the upper lip is close, and the distance between the nose bottom and the upper lip is similar in size to the interlabial distance, if a shooting device is not moving and the head undergoes head up, head down, left turn, and right turn movements (or if the head remains stationary and the shooting device tilts up and down or rotates left and right), the impact on the interlabial distance and the distance between the nose bottom and the upper lip is basically the same. Therefore, taking the distance between the nose bottom and the upper lip as the reference value for interlabial distance can reduce the interference of the shooting angle and improve the robustness of the lip movement detection method.

Exemplarily, with a geometric center of a face as the origin, a direction from left of the face to right of the face as the x-axis, a direction from a chin to a forehead as the y-axis, and a direction from a back of the head to the face as the z-axis, a coordinate system which moves with the face is established, where the x-axis, the y-axis, and the z-axis are perpendicular to each other. If the shooting device is not moving, the impact of the angle change on the y-axis (head up or down) or the angle change on the x-axis (head left or right) on the distance between the nose bottom and the upper lip is basically the same.

In an embodiment of the present application, the reference value for interlabial distance may also be a length of a nose of the user in the first image frame.

In addition, the distance between the nose and the upper lip is not easily affected by lip movement. Therefore, taking the distance between the nose bottom and the upper lip of the user in the first image frame or the length of the nose of the user in the first image frame as the reference value for interlabial distance can reduce the impact of lip movement on the reference interlabial distance, thereby improving the robustness of lip movement detection.

In an embodiment of the present application, the reference value for interlabial distance may be the distance between the nose bottom and the upper lip of the user in the first image frame and the length of the nose of the user in the first image frame. Specifically, the distance between the nose bottom and the upper lip of the user in the first image frame may be used as the reference value for interlabial distance to obtain a lip movement detection result. Then, the length of the nose of the user in the first image frame may be used as the reference value for interlabial distance to obtain a lip movement detection result again, to verify the accuracy of the lip movement detection result obtained by using the distance between the nose bottom and the upper lip as the reference value, and further improve the accuracy of lip movement detection.

Step 320, determining, based on a correspondence between the interlabial distance and the reference value for interlabial distance, a reference interlabial distance of the user in the first image frame.

The reference interlabial distance of the user in the first image frame may be a ratio of the interlabial distance to the reference value for interlabial distance, or a difference between the interlabial distance and the reference value for interlabial distance, as long as representing a correspondence between the interlabial distance and the reference value for interlabial distance, a calculation method of the reference interlabial distance of the user in the first image frame is not limited in the present application.

Step 330, determining, based on the reference interlabial distance of the user in the first image frame, a lip movement detection result of the user.

The lip movement detection result of the user may be determined by determining whether the reference interlabial distance of the user in the first image frame is greater than or equal to a lip movement threshold. The lip movement threshold may be a preset value. For example, if the reference interlabial distance is greater than or equal to the lip movement threshold, it can indicate that the distance between the upper lip and the lower lip is relatively large, that is, lip movement has occurred. If the reference interlabial distance is less than the lip movement threshold, it can indicate that the distance between the upper lip and the lower lip is not large enough, and it can be considered that lip movement has not occurred. The lip movement detection result of includes: a lip movement has occurred or no lip movement has occurred.

The traditional lip movement detection method uses a lip movement detection model for lip movement detection. The generalization ability and robustness of a lip movement detection model are limited by a type and a quantity of samples used to train the lip movement detection model, resulting in the generalization ability and robustness of the lip movement detection model being easily affected by factors such as sample shooting angle and shooting distance, so that leads to weak generalization ability of traditional lip movement detection methods and poor robustness of detection results. In the present embodiment, a reference interlabial distance of a user in a first image frame is determined based on a correspondence between an interlabial distance and a reference value for interlabial distance, thus the reference interlabial distance of the user in the first image frame is a relative value. When a shooting angle changes, the interlabial distance and the reference value for interlabial distance will both decrease or increase simultaneously. Therefore, there is not much or even no change in the reference interlabial distance of determined based on the correspondence between the interlabial distance and the reference value for interlabial distance. That is, the reference interlabial distance of the user in the first image frame is not easily affected by factors such as shooting angle and shooting distance, thereby improving the robustness of the lip movement detection method. In addition, the present application carries out lip movement detection for the first image frame, which is not limited to a type and a quantity of training samples, thereby having a strong generalization ability.

FIG. 4 shows a flowchart of a lip movement detection method provided in another embodiment of the present application. The embodiment shown in FIG. 4 is extended based on the embodiment shown in FIG. 3. The following focuses on differences between the embodiment shown in FIG. 4 and the embodiment shown in FIG. 3, and the similarities will not be repeated.

As shown in FIG. 4, in an embodiment of the present application, the step of determining, based on the reference interlabial distance of the user in the first image frame, a lip movement detection result of the user includes the following steps.

Step 410, determining n historical image frames with timing prior to and adjacent to the first image frame.

n is a positive integer less than or equal to 30. The first image frame may be one of the frames in a to-be-detected video. The to-be-detected video may be a video recorded during human-computer interaction, including a face.

Exemplarily, the first image frame may be a t-th frame image in the to-be-detected video, where t is a positive integer. When t equals 1, no lip movement detection can be carried out due to the absence of historical image frames, or a preset lip movement threshold can be used for lip movement detection. When t is greater than or equal to 2, lip movement detection can be performed using a historical image frame. The n historical image frames adjacent to the first image frame may be the (t−n)-th to (t−1)-th frames of the to-be-detected video. The number of frames of the to-be-detected video is w, and n is less than w.

A sliding window may be used to determine the n historical image frames adjacent to the first image frame. For example, the t-th frame may be used as an end of the sliding window, with n+1 as a window length, that is, the beginning of the sliding window is the (t−n)-th frame. For example, if t=10 and n=9 are set, the sliding window includes images from the 1-st frame to the 10-th frame, where the 10-th frame is the first image frame and the 1-st frame to 9-th frame are historical image frames.

Step 420, determining, based on reference interlabial distances of the user in all historical image frames of the n frames, the reference interlabial distance of the user in the first image frame, and a lip movement threshold, the lip movement detection result of the user.

The method of determining the reference interlabial distance of the user in all historical image frames in the n frames may refer to step 320, which will not be repeated here.

The lip movement threshold may be a preset value. In the step of determining, based on the reference interlabial distances of the user in all historical image frames of the n frames, the reference interlabial distance of the user in the first image frame, and a lip movement threshold, the lip movement detection result of the user: differences between the reference interlabial distance of the user in all historical image frames in the n frames and the reference interlabial distance of the user in the first image frame may be calculated respectively, to obtain multiple differences, and whether the multiple differences meet the lip movement threshold may be determined respectively. If any one of the multiple differences meets the lip movement threshold, it can be considered that the lip movement detection result of the user in the first image frame is: a lip movement has occurred. If multiple differences do not meet the lip movement threshold, it can be considered that the lip movement detection result of the user in the first image frame is: no lip movement has occurred. In a practical application, the difference meeting the lip movement threshold may be: a difference is greater than or equal to the lip movement threshold.

Exemplarily, the images included in the sliding window may from the 1-st frame to the 10-th frame, where the 10-th frame is the first image frame and the 1-st frame to the 9-th frame are historical image frames. For example, the lip movement threshold is 0.3, if the difference is greater than 0.3, it indicates that the difference meets the lip movement threshold. The reference interlabial distance of the user in the first image frame is 0.81, and the reference interlabial distances of the user in the historical image frames from the 1-st frame to the 9-th frame are 0.48, 0.75, 0.64, 0.55, 0.48, 0.85, 0.92, 0.72, and 0.73, respectively. Therefore, the differences between the reference interlabial distance of the user in the historical image frames from the 1-st frame to the 9-th frame and the reference interlabial distance of the user in the first image frame are 0.33, 0.06, 0.17, 0.26, 0.33, 0.04, 0.11, 0.09, and 0.08, respectively. It can be seen that 0.33 is greater than 0.3, which means that there two differences of the reference interlabial distances meet the lip movement threshold. It can be considered that the lip movement detection result of the user in the first image frame is: a lip movement has occurred.

The sliding window may include different image frames at different time nodes. For example, the image frames included in the sliding window at a first time node may be the 1-st frame to the 9-th frame. Assuming a sliding step of the sliding window is 1 frame, the image frames included in the sliding window at a second time node (i.e. after sliding once) may be the 2-nd frame to the 10-th frame, and the image frames included in the sliding window at a third time node (i.e. after sliding again) may be the 3-rd frame to the 11-th frame, and so on.

Exemplarily, if the reference interlabial distance of the user in the 2-nd frame image is an outlier, this outlier will only affect the lip movement detection result of the sliding window at the first time node and the lip movement detection result at the second time node, and will not affect the lip movement detection result of the sliding window at the third time node (because at the third time node, the sliding window does not include the 2-nd frame image). The outliers refer to a range where the reference interlabial distance is much greater than or much less than a normal reference interlabial distance. For example, a range of normal reference interlabial distance is 0.4 to 2. If there is a reference interlabial distance being 100 or 0.002, then the reference interlabial distance is an outlier.

Since the sliding window may include different image frames after each sliding, if the reference interlabial distance of the user in the first image frame of the sliding window at one time node or the reference interlabial distance of the user in the historical image frame is an outlier, it will only affect the lip movement detection results of the sliding window at limited time nodes, and will not affect the lip movement detection results of the sliding window at all time nodes, thereby improving the robustness of lip movement detection.

In an embodiment of the present application, in the step of determining, based on the reference interlabial distances of the user in all historical image frames of the n frames, the reference interlabial distance of the user in the first image frame, and a lip movement threshold, the lip movement detection result of the user: differences between the reference interlabial distance of the user in all historical image frames in the n frames and the reference interlabial distance of the user in the first image frame may be calculated respectively to obtain multiple differences, then the minimum difference and the maximum difference may be filtered out among the multiple differences, and whether the minimum difference and the maximum difference meet the lip movement threshold may be determined respectively. If any one of the minimum difference and the maximum difference meets the lip movement threshold, it can be considered that the lip movement detection result of the user in the first image frame is: a lip movement has occurred. If the minimum difference and the maximum difference do not meet the lip movement threshold, it can be considered that the lip movement detection result of the user in the first image frame is: no lip movement has occurred.

Exemplarily, the images included in the sliding window may from the 2-nd frame to the 10-th frame, where the 10-th frame is the first image frame and the 2-nd frame to the 9-th frame are historical image frames. For example, the lip movement threshold is 0.3, if the difference is greater than 0.3, it can indicate that the difference meets the lip movement threshold. The reference interlabial distance of the user in the first image frame is 0.81, and the reference interlabial distances of the user in the historical image frames from the 2-nd frame to the 9-th frame are 0.75, 0.64, 0.55, 0.48, 0.85, 0.92, 0.72, and 0.73, respectively. Therefore, the differences between the reference interlabial distance of the user in the historical image frames from the 2-nd frame to the 9-th frame and the reference interlabial distance of the user in the first image frame are 0.06, 0.17, 0.26, 0.33, 0.04, 0.11, 0.09, and 0.08, respectively. The maximum difference among the above differences is 0.33, and the minimum difference is 0.04. It can be seen that 0.33 is greater than 0.3, indicating that the maximum difference meets the lip movement threshold. It can be considered that the lip movement detection result corresponding to the first image frame is: a lip movement has occurred.

In the step of determining, based on the reference interlabial distances of the user in all historical image frames of the n frames, the reference interlabial distance of the user in the first image frame, and a lip movement threshold, the lip movement detection result of the user, a comparison object of the first image frame is the historical image frame. The first image frame and the historical image frame are generally images of the same user, and there is little change and even no change on the image resolution and shooting distance (i.e., a proportion of the face in the first image frame) of images of the same user, thereby improving the robustness of the lip movement detection method.

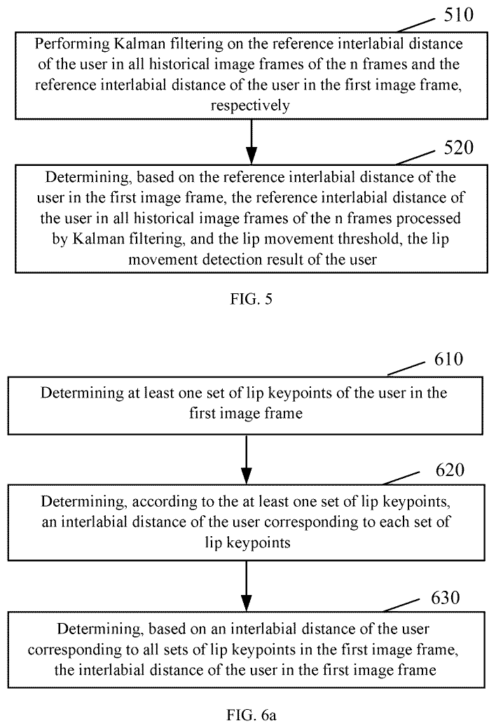

FIG. 5 shows a flowchart of a lip movement detection method provided in yet another embodiment of the present application. The embodiment shown in FIG. 5 is extended based on the embodiment shown in FIG. 4. The following focuses on differences between the embodiment shown in FIG. 5 and the embodiment shown in FIG. 4, and the similarities will not be repeated.

As shown in FIG. 5, in an embodiment of the present application, before the step of determining, based on the reference interlabial distances of the user in all historical image frames in the n frames, the reference interlabial distance of the user in the first image frame, and the lip movement threshold, the lip movement detection result of the user, the following steps are also included.

Step 510, performing Kalman filtering on the reference interlabial distance of the user in all historical image frames of the n frames and the reference interlabial distance of the user in the first image frame, respectively.

Kalman filtering processing can smooth data, reduce an impact of an outlier, and enhance the robustness of the reference interlabial distance, providing a robust data foundation for subsequent lip movement detection.

In the embodiment of the present application, the step of determining, based on the reference interlabial distances of the user in all historical image frames in the n frames, the reference interlabial distance of the user in the first image frame, and the lip movement threshold, the lip movement detection result of the user includes the following steps.

Step 520, determining, based on the reference interlabial distance of the user in the first image frame, the reference interlabial distance of the user in all historical image frames of the n frames processed by Kalman filtering, and the lip movement threshold, the lip movement detection result of the user.

The specific method for determining, based on the reference interlabial distance of the user in the first image frame, the reference interlabial distance of the user in all historical image frames of the n frames processed by Kalman filtering, and the lip movement threshold, the lip movement detection result of the user can be referred to step 420, which will not be repeated here.

FIG. 6a shows a flowchart of a lip movement detection method provided in yet another embodiment of the present application. The embodiment shown in FIG. 6a is extended based on the embodiment shown in FIG. 3. The following focuses on the differences between the embodiment shown in FIG. 6a and the embodiment shown in FIG. 3, and the similarities will not be repeated.

As shown in FIG. 6a, in an embodiment of the present application, the step of determining, based on the first image frame including the facial region of the user, the interlabial distance of the user in the first image frame includes the following steps.

Step 610, determining at least one set of lip keypoints of the user in the first image frame.

The set of lip keypoints includes upper lip inner keypoints, upper lip outer keypoints, lower lip inner keypoints, and lower lip outer keypoints that are basically located on the same line; where the upper lip inner keypoints and the upper lip outer keypoints are used to represent a position of the upper lip, while the lower lip inner keypoints and the lower lip outer keypoints are used to represent a position of the lower lip.

Step 620, determining, according to the at least one set of lip keypoints, an interlabial distance of the user corresponding to each set of lip keypoints.

Exemplarily, in the step of determining, according to the at least one set of lip keypoints, an interlabial distance of the user corresponding to each set of lip keypoints, an interlabial distance of the user corresponding to any set of lip keypoints in the at least one set of lip keypoints may be determined by the following manners: calculating average upper lip coordinates of the upper lip inner keypoints and the upper lip outer keypoints in the set of lip keypoints, and average lower lip coordinates of the lower lip inner keypoints and the lower lip outer keypoints; and determining, based on the average upper lip coordinates and the average lower lip coordinates, the interlabial distance of the user corresponding to the set of lip keypoints.

Step 630, determining, based on an interlabial distance of the user corresponding to all sets of lip keypoints in the first image frame, the interlabial distance of the user in the first image frame.

Exemplarily, the determining, based on an interlabial distance of the user corresponding to all sets of lip keypoints in the first image frame, the interlabial distance of the user in the first image frame may be executed as follows: determining an average of the interlabial distance of the user corresponding to all sets of lip keypoints in the first image frame as the interlabial distance of the user in the first image frame.

Determining the interlabial distance of the user in the first image frame based on the at least one set of lip keypoints, there is no need to extract texture features of the first image frame, thus it is not easily affected by the lip color differences of the user in the first image frame, and further improves the accuracy of lip movement detection. In addition, the calculation of the average value above is simple and reliable, with less steps, thereby consuming a lower hardware resource, and achieving the fast calculation speed.

FIG. 6b shows a flowchart of a lip movement detection method provided in yet another embodiment of the present application. The embodiment shown in FIG. 6b is extended based on the embodiment shown in FIG. 3. The following focuses on the differences between the embodiment shown in FIG. 6b and the embodiment shown in FIG. 3, and the similarities will not be repeated.

As shown in FIG. 6b, in an embodiment of the present application, the step of determining, based on the first image frame including the facial region of the user, the reference value for interlabial distance of the user in the first image frame includes the following steps.

Step 610, determining at least one set of lip keypoints of the user in the first image frame.

Step 640, determining, according to the at least one set of lip keypoints, a reference value for interlabial distance of the user corresponding to each set of lip keypoints.

Exemplarily, in the step of determining, according to the at least one set of lip keypoints, a reference value for interlabial distance of the user corresponding to each set of lip keypoints, an interlabial distance of the user corresponding to any set of lip keypoints in the at least one set of lip keypoints may be determined by the following manners: calculating average upper lip coordinates of the upper lip inner keypoints and the upper lip outer keypoints in the set of lip keypoints; and determining, based on the average upper lip coordinates and a set of interlabial distance reference keypoints corresponding to the set of lip key points, the reference value for interlabial distance of the user corresponding to the set of lip keypoints.

Step 650, determining, based on a reference value for interlabial distance of the user corresponding to all sets of lip keypoints in the first image frame, the reference value for interlabial distance of the user in the first image frame.

Exemplarily, the determining, based on a reference value for interlabial distance of the user corresponding to all sets of lip keypoints in the first image frame, the reference value for interlabial distance of the user in the first image frame may be executed as follows: determining an average reference value for interlabial distance of the user corresponding to all sets of lip keypoints in the first image frame as the reference value for interlabial distance of the user in the first image frame.

Determining the reference value for interlabial distance of the user in the first image frame based on the at least one set of lip keypoints, there is no need to extract texture features of the first image frame, thus it is not easily affected by the lip color differences of the user in the first image frame, and further improves the accuracy of lip movement detection. In addition, the calculation of the average value above is simple and reliable, with less steps, thereby consuming a lower hardware resource, and achieving the fast calculation speed.

In an embodiment of the present application, the determining at least one set of lip keypoints of the user in the first image frame includes: determining, based on a set of facial keypoints of the user in the first image frame, the at least one set of lip keypoints of the user. The set of lip keypoints includes upper lip inner keypoints and upper lip outer keypoints used to represent a position of an upper lip, and lower lip inner keypoints and lower lip outer keypoints used to represent a position of a lower lip.

The set of facial keypoints may be obtained by calculating a facial keypoint localization algorithm.

In an embodiment of the present application, there may be an occlusion in the first image frame. Therefore, a lip region and a reference region for interlabial distance of the user in the first image frame may be determined based on the set of facial keypoints, to determine whether the lip region and the reference region for interlabial distance are occluded. If there is no occlusion in both of the lip region and the reference region for interlabial distance, continue to perform step 610 to step 650. If there is an occlusion in the lip region or the reference region for interlabial distance, obtaining n frames of historical image frames adjacent to the first image frame, and determining a historical image frame in which neither the lip region nor the reference region for interlabial distance is occluded in the n frames of historical image frames as the first image frame, to perform step 610 to step 650. Exemplarily, the reference region for interlabial distance may be a bottom region of the nose. That is, if the reference value for interlabial distance is the distance between the nose bottom and the upper lip of the user in the first image frame, the reference region for interlabial distance is the bottom region of the nose. Exemplarily, if the reference value for interlabial distance is a length of the nose of the user in the first image frame, the reference region for interlabial distance is the nose region.

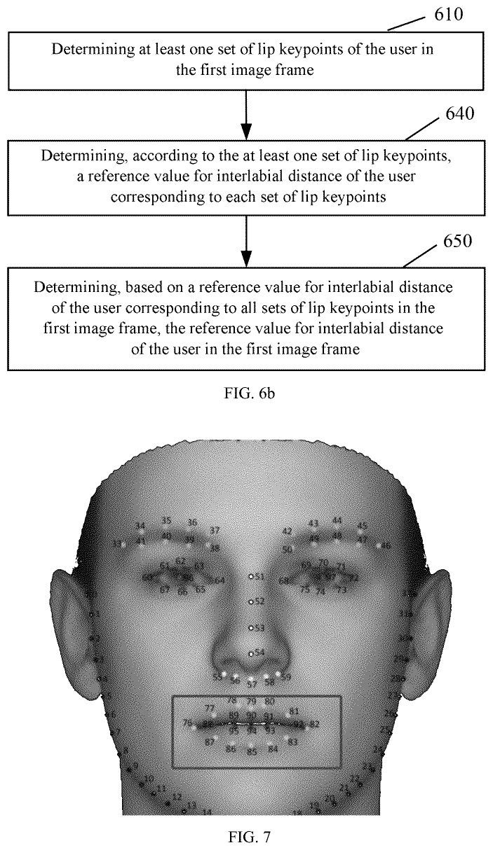

The distance between the nose bottom and the upper lip of the user in the first image frame being the reference value for interlabial distance is taken as an example described below. FIG. 7 is a schematic diagram of a first image frame including a set of facial keypoints provided in an embodiment of the present application. The set of facial keypoints may include 68 keypoints, 98 keypoints, 106 keypoints, or 468 keypoints. Under the same stability, the more keypoints there are, the stronger the robustness of the lip movement detection method. The first image frame including 98 key points, is shown in FIG. 7. Specifically, the first image frame including a set of facial keypoints output from a keypoint detection model may be obtained by inputting the first image frame into the keypoint detection model.

There are different ways for dividing the set of facial keypoints, for example, keypoints 76-87 may be considered as outer lip keypoints, and keypoints 88-95 may be considered as inner lip keypoints. For another example, keypoints 77-81 and 89-91 may be considered as upper lip keypoints, keypoints 83-87 and 93-95 as may be considered lower lip keypoints, and keypoints 76, 82, 88, and 92 may be considered as mouth corner keypoints.

In this embodiment, dividing is performed as upper lip inner keypoints, upper lip outer keypoints, lower lip inner keypoints, lower lip outer keypoints, and nose bottom keypoints. Specifically, the interlabial distance may be represented by lipDist. The interlabial distance LipDist may be calculated using the following formula (1).

$$lipDist = \frac{{Σ}_{i = 1}^{M} \sqrt{\begin{matrix}{( ( \frac{{x}_{out - down} + {x}_{i n - down}}{2} ) - ( \frac{{x}_{out - up} + {x}_{i n - up}}{2} ) )}^{2} + \\ {( ( \frac{{y}_{out - down} + {y}_{i n - down}}{2} ) - ( \frac{{y}_{out - up} + {y}_{i n - up}}{2} ) )}^{2}\end{matrix}}}{M}$$

In the formula (1), (xₒᵤₜ₋ᵤₚ, yₒᵤₜ₋ᵤₚ) represents coordinates of the upper lip outer keypoints, (xᵢₙ₋ᵤₚ, yᵢₙ₋ᵤₚ) represents coordinates of the upper lip inner keypoints, (x_{out-down}, y_{out-down}) represents coordinates of the lower lip outer keypoints, and (x_{in-down}, y_{in-down}) represents coordinates of the lower lip inner keypoints. M represents a number of sets of keypoints, and i represents a current set of lip keypoints.

Specifically, the reference value for interlabial distance may be represented by noselipDist. The reference value for interlabial distance noselipDist may be calculated using the following formula (2).

$$noseLipDist = \frac{{Σ}_{i = 1}^{M} \sqrt{\begin{matrix}{( {x}_{n o s e} - ( \frac{{x}_{out - up} + {x}_{i n - up}}{2} ) )}^{2} + \\ {( {y}_{n o s e} - ( \frac{{y}_{out - up} + {y}_{i n - up}}{2} ) )}^{2}\end{matrix}}}{M} \qquad ( 2 )$$

In the formula (2), (xₙₒₛₑ, yₙₒₛₑ) represents coordinates of the nose bottom keypoints. The other parameters have the same meaning as those represented by the formula (1).

As shown in FIG. 7, 20 keypoints from 76 to 95 are lip keypoints, and 5 key points from 55 to 59 are nose bottom keypoints (i.e., interlabial distance reference keypoints). Taking M=3 as an example, a first set of lip keypoints includes keypoints 78, 89, 95, and 86; a second set of lip keypoints includes keypoints 79, 90, 94, and 85; and a third set of lip keypoints includes keypoints 80, 91, 93, and 84. A set of interlabial distance reference keypoints corresponding to the first set of lip keypoints includes keypoint 56, a set of interlabial distance reference keypoints corresponding to the second set of lip keypoints includes keypoint 57, and a set of interlabial distance reference keypoints corresponding to the third set of lip keypoints includes keypoint 58.

The formula (1) may be used to perform step 620 and step 630, to obtain the interlabial distance of the user corresponding to each of the 3 sets of lip keypoints mentioned above. Then, based on the interlabial distance of the user corresponding to each of the 3 sets of lip keypoints, the interlabial distance of the user in the first image frame may be determined. Specifically, an average interlabial distance of the user corresponding to multiple sets of lip keypoints may be determined as the interlabial distance of the user in the first image frame.

The formula (2) may be used to perform steps 640 and 650, to determine the reference value for interlabial distance of the user in the first image frame, for the reference value for the interlabial distance of the user corresponding to each of the 3 sets of lip keypoints mentioned above. Specifically, an average reference value for interlabial distance of the user corresponding to multiple sets of lip keypoints may be determined as the reference value for interlabial distance of the user in the first image frame.

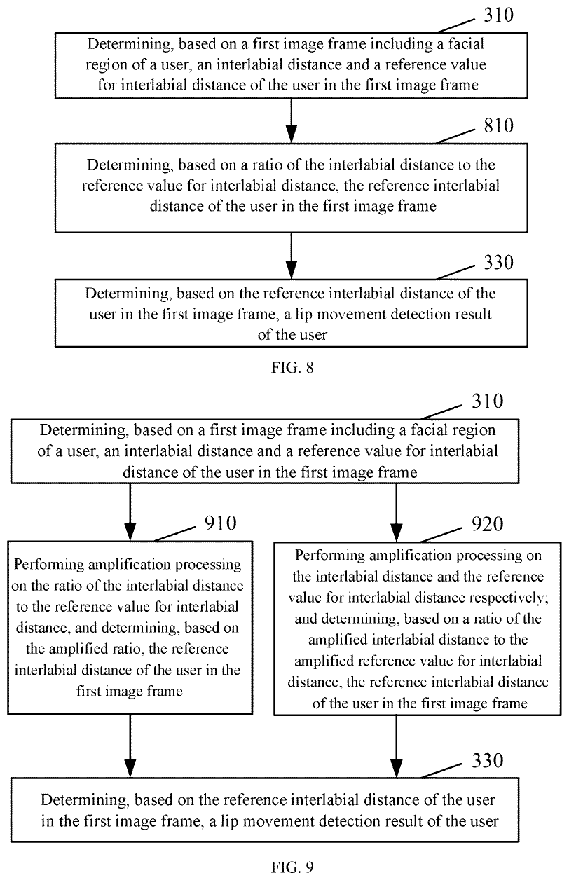

FIG. 8 shows a flowchart of a lip movement detection method provided in yet another embodiment of the present application. The embodiment shown in FIG. 8 is extended based on the embodiment shown in FIG. 3. The following focuses on the differences between the embodiment shown in FIG. 8 and the embodiment shown in FIG. 3, and the similarities will not be repeated.

As shown in FIG. 8, in an embodiment of the present application, the step of the determining, based on the correspondence between the interlabial distance and the reference value for interlabial distance, the reference interlabial distance of the user in the first image frame includes the following steps.

Step 810, determining, based on a ratio of the interlabial distance to the reference value for interlabial distance, the reference interlabial distance of the user in the first image frame.

The ratio of the interlabial distance to the reference value for interlabial distance may be represented by R, the interlabial distance may be represented by lipDist, and the reference value for interlabial distance may be represented by noselipDist. The ratio R may be calculated using the following formula (3) or formula (4). And, the ratio R is used to determine the reference interlabial distance of the user in the first image frame.

R=lipDist/noselipDist (3)

R=noselipDist/lipDist (4)

The reference interlabial distance of the user in the first image frame is directly obtained by calculating the ratio. The calculation method is simple, resource consumption is low, and thus the efficiency of lip movement detection is improved.

FIG. 9 shows a flowchart of a lip movement detection method provided in yet another embodiment of the present application. The embodiment shown in FIG. 9 is extended based on the embodiment shown in FIG. 8. The following focuses on the differences between the embodiment shown in FIG. 9 and the embodiment shown in FIG. 8, and the similarities will not be repeated.

As shown in FIG. 9, in an embodiment of the present application, the step of determining, based on the ratio of the interlabial distance to the reference value for interlabial distance, the reference interlabial distance of the user in the first image frame includes the following steps.

Step 910, performing amplification processing on the ratio of the interlabial distance to the reference value for interlabial distance; and determining, based on the amplified ratio, the reference interlabial distance of the user in the first image frame.

The amplification processing may be performed through a preset amplification function. The preset amplification function may be an exponential function, a logarithmic function, a multiple function, and other functions that can amplify a numerical value.

The reference interlabial distance may be represented by C. The reference interlabial distance C may be calculated using the following formulas (5), (6), or (7).

C=log a^{R} (5)

C=b^{R} (6)

C=dR (7)

Among them, a>1, b>1, d>1. R represents the ratio of the interlabial distance to the reference value for interlabial distance.

Step 920, performing amplification processing on the interlabial distance and the reference value for interlabial distance respectively; and determining, based on a ratio of the amplified interlabial distance to the amplified reference value for interlabial distance, the reference interlabial distance of the user in the first image frame.

The specific method of performing amplification processing on the interlabial distance and the reference value for interlabial distance may refer to formulas (5) to (7), that is, replacing the ratio R in formulas (5) to (7) with the interlabial distance or the reference value for interlabial distance, which will not be repeated here.

The reference interlabial distance corresponding to the first image frame may be determined through step 910, or the reference interlabial distance corresponding to the first image frame may be determined through step 920.

Performing amplification processing on the ratio of the interlabial distance to the reference value for interlabial distance, or performing amplification processing on the interlabial distance and the reference value for interlabial distance respectively to amplify the value of the reference interlabial distance, a change in lip movement is made more significant, thus improving the accuracy of the lip movement detection method.

An embodiment of the present application further provides a lip movement detection method for a virtual digital human, including: obtaining a to-be-processed video including a facial region of the virtual digital human; and processing, based on the lip movement detection method provided by the above embodiments, an image frame included in the to-be-processed video, to obtain a lip movement detection result of the virtual digital human.

The virtual digital human is a comprehensive product that exists in a non-physical world and has multiple human characteristics, such as image ability, expressive ability, and perceptual and interactive ability. Specifically, the image ability of the virtual digital human refers to that the virtual digital human has specific characteristics such as an appearance, a gender, and a personality. The expressive ability of the virtual digital human refers to that the virtual digital human has ability for expressing through a speech, a facial expression, and a body movement. The perceptual and interactive ability of the virtual digital human refers to that the virtual digital human has ability for recognizing the external environment and communicating and interacting with people.

Exemplarily, the virtual digital human may be an assistant type virtual digital human (such as, a virtual customer service, a virtual tour guide, an intelligent assistant and etc.), an entertainment type virtual digital human (such as, a virtual singer, a virtual spokesperson and etc.), as well as a host type virtual digital human such as (a virtual streamer, a virtual host and etc.).

Exemplarily, the scenario of lip movement detection for a virtual digital human includes a server and a client communicating and connecting with the server. Specifically, the server determines, based on a first image frame including a facial region of the virtual digital human, an interlabial distance and a reference value for interlabial distance of the virtual digital human in the first image frame; determines, based on a correspondence between the interlabial distance and the reference value for interlabial distance, a reference interlabial distance of the virtual digital human in the first image frame; and determines, based on the reference interlabial distance of the virtual digital human in the first image frame, a lip movement detection result of the virtual digital human. The client is configured to obtain the first image frame including the facial region of the virtual digital human, and sends the first image frame to the server for the server to perform the above operations.

Exemplarily, the lip movement detection method for a virtual digital human may be applied to a virtual concert scenario. The virtual concert scenario includes a processor, a display communicating and connecting with the processor, and an image acquisition apparatus communicating and connecting with the processor. The display is configured to display the virtual digital human (i.e., a virtual singer). The image acquisition apparatus is configured to capture a first image frame including a facial region of the virtual singer and send the first image frame to the processor. The processor determines a lip movement detection result of the virtual singer using the lip movement detection method for a virtual digital human mentioned above. The processor may further determine whether singing is consistent with a frequency of lip movements based on the lip movement detection results of the virtual singer, so as to adjust the frequency of lip movements of the virtual singer promptly when singing is not consistent with the frequency of lip movements, thereby improving the live experience of fans.

Exemplarily, the lip movement detection method for a virtual digital human may be applied to a customer service scenario. The customer service scenario includes: a processor, a display communicating and connecting with the processor, and an image acquisition apparatus communicating and connecting with the processor. The display is configured to display the virtual digital humans (i.e., a virtual customer service). The image acquisition apparatus is configured to capture a first image frame including a facial region of the virtual customer service and a first image frame including a facial region of a consulting customer, and send the first image frame including the facial region of the virtual customer service and the first image frame including the facial region of the consulting customer to the processor. The processor determines a lip movement detection result of the virtual customer service using the lip movement detection method for a virtual digital human mentioned above, and determines a lip movement detection result of the consulting customer using the lip movement detection method mentioned above. The processor may further determine whether the virtual customer service communicates with the consulting customer normally based on the lip movement detection result of the virtual customer service and the lip movement detection result of the consulting customer. Specifically, judging whether the virtual customer service stops speaking promptly (i.e., the virtual customer service stops lip movements) when the consulting customer is speaking (i.e. the consulting customer has lip movements), may avoid that the virtual customer service and the consulting customer speak at the same time. In addition, judging whether the virtual customer service speaks promptly (i.e., the virtual customer service has lip movements) for responding to a question of the customer after the virtual customer has stopped speaking (i.e., the customer stops lip movements), may avoid a situation where the virtual customer service does not respond to the question of the customer promptly.

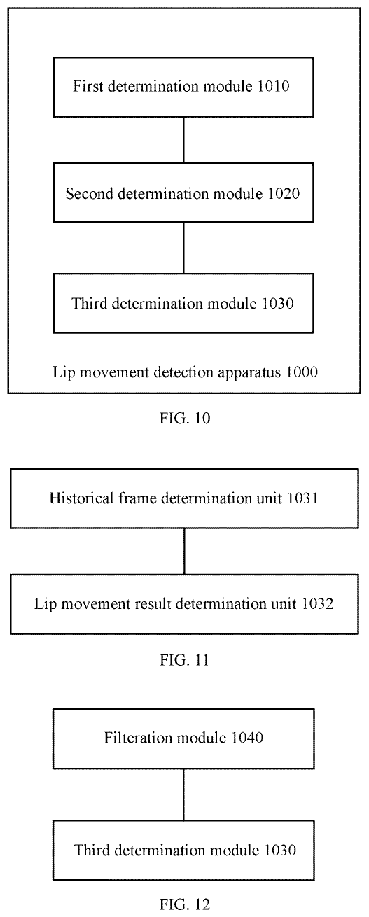

The above text, combined with FIGS. 1 to 9, provides a detailed description of the method embodiments of the present application. The following text, combined with FIGS. 10 to 15, provides a detailed description of the device embodiments of the present application. It should be understood that the description of the method embodiment corresponds to the description of the device embodiment, therefore, the parts that are not described in detail can refer to the previous method embodiment.

The foregoing paragraphs, in conjunction with FIG. 1 to FIG. 9, provide a detailed description of the method embodiments of the present application. The following text, in conjunction with FIG. 10 to FIG. 15, provides a detailed description of apparatus embodiment of the present application. It should be understood that the description of the method embodiment corresponds to the description of the apparatus embodiment, therefore, the parts that are not described in detail can refer to the previous method embodiment.

FIG. 10 shows a structure schematic diagram of a lip movement detection apparatus provided in an embodiment of the present application. As shown in FIG. 10, a lip movement detection apparatus 1000 of the present embodiment includes: a first determination module 1010, a second determination module 1020, and a third determination module 1030.

The first determination module 1010 is configured to determine, based on a first image frame including a facial region of a user, an interlabial distance and a reference value for interlabial distance of the user in the first image frame. The second determination module 1020 is configured to determine, based on a correspondence between the interlabial distance and the reference value for interlabial distance, a reference interlabial distance of the user in the first image frame. The third determination module 1030 is configured to determine, based on the reference interlabial distance of the user in the first image frame, a lip movement detection result of the user.

In an embodiment of the present application, the reference value for interlabial distance includes a distance between a nose bottom and an upper lip of the user in the first image frame, and/or a length of a nose of the user in the first image frame.

FIG. 11 shows a structure schematic diagram of a lip movement detection apparatus provided in another embodiment of the present application. The embodiment shown in FIG. 11 is extended based on the embodiment shown in FIG. 10. The following focuses on differences between the embodiment shown in FIG. 11 and the embodiment shown in FIG. 10, and the similarities will not be repeated.

As shown in FIG. 11, in an embodiment of the present application, the third determination module 1030 of includes: a historical frame determination unit 1031 and a lip movement result determination unit 1032.

The historical frame determination unit 1031 is configured to determine n historical image frames with timing prior to and adjacent to the first image frame, where n is a positive integer less than or equal to 30. The lip movement result determination unit 1032 is configured to determine, based on reference interlabial distances of the user in all historical image frames of the n frames, the reference interlabial distance of the user in the first image frame, and a lip movement threshold, the lip movement detection result of the user.

FIG. 12 shows a structure schematic diagram of a lip movement detection apparatus provided in yet another embodiment of the present application. The embodiment shown in FIG. 12 is extended based on the embodiment shown in FIG. 11. The following focuses on differences between the embodiment shown in FIG. 12 and the embodiment shown in FIG. 11, and the similarities will not be repeated.

As shown in FIG. 12, in an embodiment of the present application, the lip movement detection apparatus 1000 further includes a filteration module 1040.

The filteration module 1040 is configured to perform Kalman filtering on the reference interlabial distance of the user in all historical image frames of the n frames and the reference interlabial distance of the user in the first image frame, respectively. The lip movement result determination unit 1032 is further configured to determine, based on the reference interlabial distance of the user in the first image frame, the reference interlabial distance of the user in all historical image frames of the n frames processed by Kalman filtering, and the lip movement threshold, the lip movement detection result of the user.

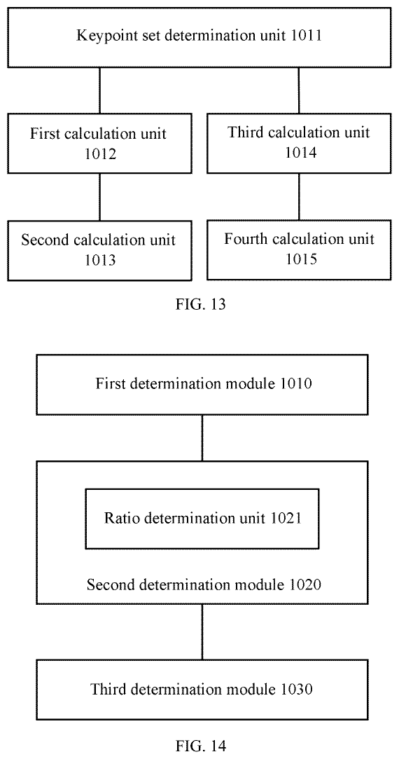

FIG. 13 shows a structure schematic diagram of a lip movement detection apparatus provided in yet another embodiment of the present application. The embodiment shown in FIG. 13 is extended based on the embodiment shown in FIG. 10. The following focuses on differences between the embodiment shown in FIG. 13 and the embodiment shown in FIG. 10, and the similarities will not be repeated.

As shown in FIG. 13, in an embodiment of the present application, the first determination module 1010 includes: a keypoint set determination unit 1011, a first calculation unit 1012, a second calculation unit 1013, a third calculation unit 1014, and a fourth calculation unit 1015.

The keypoint set determination unit 1011 is configured to determine at least one set of lip keypoints of the user in the first image frame. The first calculation unit 1012 is configured to determine, according to the at least one set of lip keypoints, an interlabial distance of the user corresponding to each set of lip keypoints. The second calculation unit 1013 is configured to determine, based on an interlabial distance of the user corresponding to all sets of lip keypoints in the first image frame, the interlabial distance of the user in the first image frame. The third calculation unit 1014 is configured to determine, according to the at least one set of lip keypoints, a reference value for interlabial distance of the user corresponding to each set of lip keypoints. The fourth calculation unit 1015 is configured to determine, based on a reference value for interlabial distance of the user corresponding to all sets of lip keypoints in the first image frame, the reference value for interlabial distance of the user in the first image frame.

In an embodiment of the present application, the keypoint set determination unit 1011 is further configured to determine, based on a set of facial keypoints of the user in the first image frame, the at least one set of lip keypoints of the user, where the set of lip keypoints includes upper lip inner keypoints and upper lip outer keypoints used to represent a position of an upper lip, and lower lip inner keypoints and lower lip outer keypoints used to represent a position of a lower lip.

In an embodiment of the present application, the first computing unit 1012 is further configured to determine the interlabial distance of a user corresponding to any set of lip key points in at least one set of lip key points by calculating the average upper lip coordinates of the upper lip inner key points and the upper lip outer key points in the set of lip key points, as well as the average lower lip coordinates of the lower lip inner key points and the lower lip outer key points. Based on the average upper lip coordinates and the average lower lip coordinates, the interlabial distance of the user corresponding to the set of lip key points is determined.

In an embodiment of the present application, the third computing unit 1014 is further configured to determine a reference value for interlabial distance of the user corresponding to any set of lip keypoints in the at least one set of lip keypoints by: calculating average upper lip coordinates of the upper lip inner keypoints and the upper lip outer keypoints in the set of lip keypoints; and determining, based on the average upper lip coordinates and a set of interlabial distance reference keypoints corresponding to the set of lip key points, the reference value for interlabial distance of the user corresponding to the set of lip keypoints.

FIG. 14 shows a structure schematic diagram of a lip movement detection apparatus provided in yet another embodiment of the present application. The embodiment shown in FIG. 14 is extended based on the embodiment shown in FIG. 10. The following focuses on differences between the embodiment shown in FIG. 14 and the embodiment shown in FIG. 10, and the similarities will not be repeated.

As shown in FIG. 14, in an embodiment of the present application, the second determination module 1020 includes a ratio determination unit 1021.

The ratio determination unit 1021 is configured to determine, based on a ratio of the interlabial distance to the reference value for interlabial distance, the reference interlabial distance of the user in the first image frame.

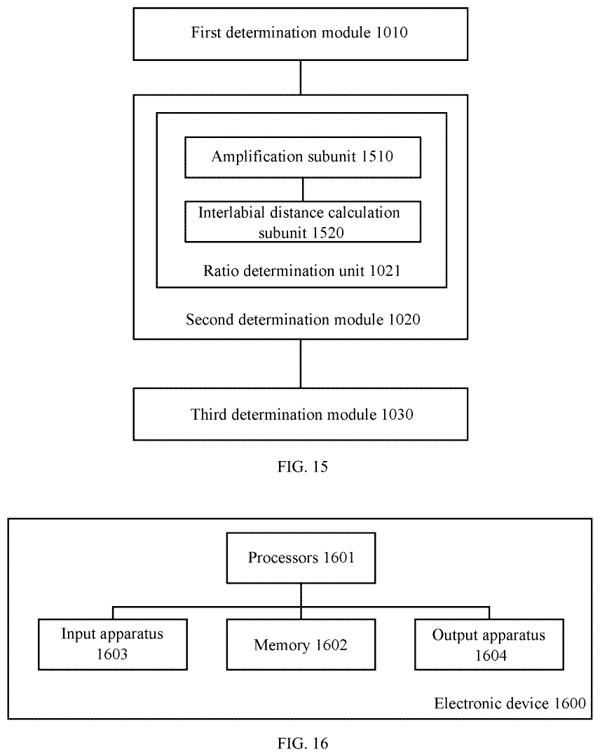

FIG. 15 shows a structure schematic diagram of a lip movement detection apparatus provided in yet another embodiment of the present application. The embodiment shown in FIG. 15 is extended based on the embodiment shown in FIG. 14. The following focuses on differences between the embodiment shown in FIG. 15 and the embodiment shown in FIG. 14, and the similarities will not be repeated.

As shown in FIG. 15, the ratio determination unit 1021 of the present embodiment includes: an amplification subunit 1510 and an interlabial distance calculation subunit 1520.

The amplification subunit 1510 is configured to perform amplification processing on the ratio of the interlabial distance to the reference value for interlabial distance. The interlabial distance calculation subunit 1520 is configured to determine, based on the amplified ratio, the reference interlabial distance of the user in the first image frame.

In an embodiment of the present application, the amplification subunit 1510 is configured to perform amplification processing on the interlabial distance and the reference value for interlabial distance respectively. The interlabial distance calculation subunit 1520 is configured to determine, based on a ratio of the amplified interlabial distance to the amplified reference value for interlabial distance, the reference interlabial distance of the user in the first image frame.

An embodiment of the present application further provides a lip movement detection device for a virtual digital human, including an acquisition module and a detection module. The acquisition module is configured to obtain a to-be-processed video including a facial region of the virtual digital human. The detection module is configured to process an image frame included in the to-be-processed video based on the lip movement detection method provided by the above embodiments, to obtain a lip movement detection result of the virtual digital human.

The operation and function of the first determination module 1010, the second determination module 1020, the third determination module 1030, the filteration module 1040, and further the historical frame determination unit 1031 and lip movement result determination unit 1032 included in the third determination module 1030, as well as the key point set determination unit 1011, first calculation unit 1012, second calculation unit 1013, third calculation unit 1014, and fourth calculation unit 1015 included in the first determination module 1010, as well as the ratio determination unit 1021 included in the second determination module 1020, as well as the amplification subunit 1510 and interlabial distance calculation subunit 1520 included in the ratio determination unit 1021, all of which are included in the lip movement detection apparatus provided in FIG. 10 to FIG. 15, can refer to the lip movement detection methods provided in FIG. 3 to FIG. 9 above. The similarities will not be repeated in order to avoid repetition.

FIG. 16 shows a structure schematic diagram of an electronic device provided in an embodiment of the present application. As shown in FIG. 16, the electronic device 1600 includes: one or more processors 1601 and a memory 1602; and computer program instructions stored in the memory 1602, which cause the processor 1601 to execute the lip movement detection method as described in any of the above embodiments when run by the processor 1601.

The processor 1601 may be a central processing unit (Central Processing Unit, CPU) or another form of processing unit with data transmission and/or instruction execution capabilities, and may control other components in the electronic device to perform a desired function.

The memory 1602 may include one or more computer program products, which may include various forms of computer-readable storage medium, such as a volatile memory and/or a non-volatile memory. The volatile memory may include, for example, a random access memory (Random Access Memory, RAM) and/or a cache memory (Cache), and etc. The non-volatile memory may include, for example, a read only memory (Read Only Memory, ROM), a hard disk, a flash memory, and etc. One or more computer program instructions may be stored on the computer-readable storage medium, and the processor 1601 may run the program instructions to implement the steps and/or other desired functions of the lip movement detection method in the various embodiments of the present application as described above.

In an example, the electronic device 1600 may further include an input apparatus 1603 and an output apparatus 1604, which are interconnected through a bus system and/or other forms of connection mechanisms (not shown in FIG. 16).

In addition, the input apparatus 1603 may further include, for example, a keyboard, a mouse, a microphone, and etc.

The output apparatus 1604 may output various information externally. The output apparatus 1604 may include, for example, a display, a speaker, a printer, and a communication network and connected remote output device thereof, and etc.

Of course, for simplicity, only some of the components related to the present application in the electronic device 1600 are shown in FIG. 16, and components such as a bus, an input apparatus/output interface, etc. are omitted. In addition, depending on the specific application, the electronic device 1600 may further include any other appropriate components.

In addition to the above methods and devices, an embodiment of the present application may also be a computer program product, including computer program instructions, which cause a processor to execute steps of the lip movement detection method as described in any of the above embodiments when run by the processor.

The computer program product may be written in any combination of one or more programming languages to write program codes for executing the operation of the embodiment of the present application. The programming languages include an object-oriented programming language, such as, Java, C++, as well as a conventional procedural programming language such as “C” language or similar programming languages. The program instructions may be completely executed on a user computing device, partially executed on a user device, executed as an independent software package, partially executed on a user computing device and partially executed on a remote computing device, or completely executed on a remote computing device or a server.

In addition, an embodiment of the present application further provides a computer-readable storage medium storing with computer program instructions, when executed by a processor, the computer program instructions cause the processor to perform the steps of the lip movement detection method described in the “exemplary methods” section of this specification according to various embodiments of the present application.

An embodiment of the present application further provides a computer program that, when executed by a processor, implements the steps of the lip movement detection method described in the “exemplary methods” section of this specification according to various embodiments of the present application.

An embodiment of the present application further provides a computer program product including a computer program that, when executed by a processor, implements the steps of the lip movement detection method described in the “exemplary methods” section of this specification according to various embodiments of the present application.

The computer-readable storage medium may use any combination of one or more readable media. The readable medium may be a readable signal medium or a readable storage medium. A readable storage medium may include, but is not limited to, a system, an apparatus, or a device of electricity, magnetism, light, electromagnetism, infrared, or semiconductors, or any combination thereof. More specific examples of the readable storage medium (non-exhaustive list) include: an electrical connection with one or more wires, a portable disk, a hard drive, an RAM, an ROM, an erasable programmable ROM (Erasable Programmable ROM, EPROM) or a flash memory, a fiber optic, a compact disk ROM (Compact Disk ROM, CD-ROM), an optical storage device, a magnetic storage device, or any suitable combination of the above.

The above describes the basic principles of the present application in conjunction with specific embodiments. However, it should be pointed out that the advantages, virtues, effects, etc. mentioned in the present application are only examples and not limitations, and cannot be considered as essential for each embodiment of the present application. In addition, the specific details disclosed above are only for the purpose of providing examples and facilitating understanding, and are not limited. The above details do not limit the necessity for the present application to use the above specific details for implementation.

The block diagrams of the components, apparatus, devices, and systems involved in the present application are only illustrative examples and are not intended to require or imply that they must be connected, arranged, or configured in the manner shown in the block diagrams. As person skilled in the art will recognize, these components, apparatus, devices, and systems may be connected, arranged, and configured in any way. Words such as “including”, “comprising”, “having”, etc. are open terms that refer to “including but not limited to” and may be used interchangeably. The terms “or” and “and” used herein refer to the words “and/or” and can be used interchangeably, unless the context clearly indicates otherwise. The term “such as” used herein refers to the phrase “such as but not limited to” and may be used interchangeably.

It should further be pointed out that in the apparatus, device, and method of the present application, each component or step can be decomposed and/or recombined. These decompositions and/or recombinations should be considered equivalent solutions to the present application.

The above provided description of the disclosed aspects enables any person skilled in the art to make or use the present application. Various modifications to these aspects are very obvious to the person skilled in the art, and the general principles defined herein can be applied to other aspects without departing from the scope of the present application. Therefore, the present application is not intended to be limited to the aspects shown herein, but rather to the widest range consistent with the principles and novel features disclosed herein.

The above description has been provided for the purpose of illustration and description. Furthermore, this description is not intended to limit the embodiments of the present application to the form disclosed herein. Although multiple exemplary aspects and embodiments have been discussed above, the person skilled in the art will recognize certain variations, modifications, alterations, additions, and sub combinations thereof.

The above are only preferred embodiments of the present application and are not intended to limit the present application. Any modifications, equivalent substitutions, etc. made within the spirit and principles of the present application shall be included within the scope of protection of the present application.

What is claimed is:

1. A detection method, comprising:
determining, based on a first image frame comprising a facial region of a user, an interlabial distance and a reference value for interlabial distance of the user in the first image frame;
determining, based on a correspondence between the interlabial distance and the reference value for interlabial distance, a reference interlabial distance of the user in the first image frame; and
determining, based on the reference interlabial distance of the user in the first image frame, a lip movement detection result of the user.

2. The lip movement detection method according to claim 1, wherein the reference value for interlabial distance comprises a distance between a nose bottom and an upper lip of the user in the first image frame, and/or a length of a nose of the user in the first image frame.

3. The lip movement detection method according to claim 1, wherein the determining, based on the reference interlabial distance of the user in the first image frame, the lip movement detection result of the user, comprises:
determining n historical image frames with timing prior to and adjacent to the first image frame, wherein n is a positive integer less than or equal to 30; and
determining, based on reference interlabial distances of the user in all historical image frames of the n frames, the reference interlabial distance of the user in the first image frame, and a lip movement threshold, the lip movement detection result of the user.

4. The lip movement detection method according to claim 2, wherein the determining, based on the reference interlabial distance of the user in the first image frame, the lip movement detection result of the user, comprises:
determining n historical image frames with timing prior to and adjacent to the first image frame, wherein n is a positive integer less than or equal to 30; and
determining, based on reference interlabial distances of the user in all historical image frames of the n frames, the reference interlabial distance of the user in the first image frame, and a lip movement threshold, the lip movement detection result of the user.

5. The lip movement detection method according to claim 3, wherein before the determining, based on the reference interlabial distances of the user in all historical image frames in the n frames, the reference interlabial distance of the user in the first image frame, and the lip movement threshold, the lip movement detection result of the user, the method further comprises:
performing Kalman filtering on the reference interlabial distance of the user in all historical image frames of the n frames and the reference interlabial distance of the user in the first image frame, respectively;
wherein the determining, based on the reference interlabial distances of the user in all historical image frames in the n frames, the reference interlabial distance of the user in the first image frame, and the lip movement threshold, the lip movement detection result of the user, comprises:
determining, based on the reference interlabial distance of the user in the first image frame, the reference interlabial distance of the user in all historical image frames of the n frames processed by Kalman filtering, and the lip movement threshold, the lip movement detection result of the user.

6. The lip movement detection method according to claim 4, wherein before the determining, based on the reference interlabial distances of the user in all historical image frames in the n frames, the reference interlabial distance of the user in the first image frame, and the lip movement threshold, the lip movement detection result of the user, the method further comprises:
performing Kalman filtering on the reference interlabial distance of the user in all historical image frames of the n frames and the reference interlabial distance of the user in the first image frame, respectively;
wherein the determining, based on the reference interlabial distances of the user in all historical image frames in the n frames, the reference interlabial distance of the user in the first image frame, and the lip movement threshold, the lip movement detection result of the user, comprises:
determining, based on the reference interlabial distance of the user in the first image frame, the reference interlabial distance of the user in all historical image frames of the n frames processed by Kalman filtering, and the lip movement threshold, the lip movement detection result of the user.

7. The lip movement detection method according to claim 1, wherein the determining, based on the first image frame comprising the facial region of the user, the interlabial distance of the user in the first image frame, comprises:
determining at least one set of lip keypoints of the user in the first image frame;
determining, according to the at least one set of lip keypoints, an interlabial distance of the user corresponding to each set of lip keypoints; and
determining, based on an interlabial distance of the user corresponding to all sets of lip keypoints in the first image frame, the interlabial distance of the user in the first image frame.

8. The lip movement detection method according to claim 1, wherein the determining, based on the first image frame comprising the facial region of the user, the reference value for interlabial distance of the user in the first image frame, comprises:
determining at least one set of lip keypoints of the user in the first image frame;
determining, according to the at least one set of lip keypoints, a reference value for interlabial distance of the user corresponding to each set of lip keypoints; and
determining, based on a reference value for interlabial distance of the user corresponding to all sets of lip keypoints in the first image frame, the reference value for interlabial distance of the user in the first image frame.

9. The lip movement detection method according to claim 7, wherein the determining the at least one set of lip keypoints of the user in the first image frame, comprises:
determining, based on a set of facial keypoints of the user in the first image frame, the at least one set of lip keypoints of the user, wherein the set of lip keypoints comprises upper lip inner keypoints and upper lip outer keypoints used to represent a position of an upper lip, and lower lip inner keypoints and lower lip outer keypoints used to represent a position of a lower lip.

10. The lip movement detection method according to claim 8, wherein the determining the at least one set of lip keypoints of the user in the first image frame, comprises:
determining, based on a set of facial keypoints of the user in the first image frame, the at least one set of lip keypoints of the user, wherein the set of lip keypoints comprises upper lip inner keypoints and upper lip outer keypoints used to represent a position of an upper lip, and lower lip inner keypoints and lower lip outer keypoints used to represent a position of a lower lip.

11. The lip movement detection method according to claim 7, wherein the determining, according to the at least one set of lip keypoints, the interlabial distance of the user corresponding to each set of lip keypoints, comprises:
determining an interlabial distance of the user corresponding to any set of lip keypoints in the at least one set of lip keypoints by:
calculating average upper lip coordinates of the upper lip inner keypoints and the upper lip outer keypoints in the set of lip keypoints, and average lower lip coordinates of the lower lip inner keypoints and the lower lip outer keypoints; and determining, based on the average upper lip coordinates and the average lower lip coordinates, the interlabial distance of the user corresponding to the set of lip keypoints.

12. The lip movement detection method according to claim 8, wherein the determining, according to the at least one set of lip keypoints, the reference value for interlabial distance of the user corresponding to each set of lip keypoints, comprises:
determining a reference value for interlabial distance of the user corresponding to any set of lip keypoints in the at least one set of lip keypoints by:
calculating average upper lip coordinates of the upper lip inner keypoints and the upper lip outer keypoints in the set of lip keypoints; and determining, based on the average upper lip coordinates and a set of interlabial distance reference keypoints corresponding to the set of lip key points, the reference value for interlabial distance of the user corresponding to the set of lip keypoints.

13. The lip movement detection method according to claim 1, wherein the determining, based on the correspondence between the interlabial distance and the reference value for interlabial distance, the reference interlabial distance of the user in the first image frame, comprises:
determining, based on a ratio of the interlabial distance to the reference value for interlabial distance, the reference interlabial distance of the user in the first image frame.

14. The lip movement detection method according to claim 13, wherein the determining, based on the ratio of the interlabial distance to the reference value for interlabial distance, the reference interlabial distance of the user in the first image frame, comprises:
performing amplification processing on the ratio of the interlabial distance to the reference value for interlabial distance; and determining, based on the amplified ratio, the reference interlabial distance of the user in the first image frame; or
performing amplification processing on the interlabial distance and the reference value for interlabial distance respectively; and determining, based on a ratio of the amplified interlabial distance to the amplified reference value for interlabial distance, the reference interlabial distance of the user in the first image frame.

15. A lip movement detection method for a virtual digital human, comprising:
obtaining a to-be-processed video comprising a facial region of the virtual digital human; and
processing, based on the lip movement detection method according to claim 1, an image frame comprised in the to-be-processed video, to obtain a lip movement detection result of the virtual digital human.

16. An electronic device, comprising:
a processor; and
a memory configured to store computer executable instructions;
wherein the processor is configured to execute the computer executable instructions to:
determine, based on a first image frame comprising a facial region of a user, an interlabial distance and a reference value for interlabial distance of the user in the first image frame;
determine, based on a correspondence between the interlabial distance and the reference value for interlabial distance, a reference interlabial distance of the user in the first image frame; and
determine, based on the reference interlabial distance of the user in the first image frame, a lip movement detection result of the user.

17. An electronic device, comprising:
a processor; and
a memory configured to store computer executable instructions;
wherein the processor is configured to execute the computer executable instructions to:
obtain a to-be-processed video comprising a facial region of the virtual digital human; and
process an image frame comprised in the to-be-processed video based on the lip movement detection method according to claim 1, to obtain a lip movement detection result of the virtual digital human.

18. A non-transitory computer-readable storage medium storing with instructions that, when executed by a processor of an electronic device, enable the electronic device to execute the method according to claim 1.

19. A non-transitory computer-readable storage medium storing with instructions that, when executed by a processor of an electronic device, enable the electronic device to execute the method according to claim 15.

20. A computer program product comprising computer executable instructions, wherein the method according to claim 1 is implemented when a processor executes the computer executable instructions.
